(19) United States
(12) Patent Application Publication
(10) Pub. No.: US 2006/0101137 A1
(43) Pub. Date: May 11, 2006

(54) Maintaining apparatus, apparatus-to-be-maintained, and maintenance system

(76) Inventor: Hideo Suto, Tokyo (JP)

Correspondence Address: RABIN & Berdo, PC, 1101 14TH STREET, NW, SUITE 500, WASHINGTON, DC, 20005, US

(21) Appl. No.: 11/234,235

(22) Filed: Sep. 26, 2005

(30) Foreign Application Priority Data
Sep. 30, 2004 (JP) 2004-286551

(51) Int. Cl. G06F 15/173

(52) U.S. Cl. 709/223

(57) ABSTRACT

An apparatus is maintained by a piece of equipment through a network. The apparatus includes a reading section and a controller. The reading section automatically reads an instruction file from the maintaining equipment. The instruction file contains an instruction necessary for maintenance of the apparatus. The controller outputs a reply to a device connected to the network in response to the instruction. The reading section reads the instruction file automatically, for example, at specific time intervals.

### BACKGROUND OF THE INVENTION

1. Field of the Invention

The present invention relates to a maintenance system for remotely maintaining various information processing apparatuses connected to a network. The maintenance system includes information processing apparatuses, a maintaining apparatus, and an apparatus to be maintained by the maintaining apparatus.

2. Description of the Related Art

One conventional remotely controlled maintenance system is one in which various pieces of equipment (referred to as apparatus-to-be maintained hereinafter) send information on trouble or failure of the equipment to a maintaining apparatus upon occurrence of the trouble and failure. Another conventional system is one in which maintenance personnel operates a maintaining apparatus to obtain desired information on various pieces of equipment connected to a network.

For example, one remotely controlled maintenance system employs a maintaining apparatus with a communication protocol processing section that handles the normal communication and a maintenance protocol processing section that handles maintenance operations. Another system employs a monitor apparatus that monitors a variety of equipment connected to a network. A user operates the monitor to obtain the conditions of the equipment.

With the aforementioned remotely controlled monitor system, the equipment-to-be-maintained outputs information upon occurrence of trouble or the maintaining apparatus sends a request to the equipment-to-be-maintained and the equipment-to-be-maintained outputs information in response to the request.

However, if the apparatus-to-be-maintained is configured to send information only after a change in the condition of the apparatus-to-be-maintained has occurred, it is difficult for the maintaining apparatus to obtain any status of the apparatus-to-be-maintained before the change in the status of the apparatus-to-be-maintained has occurred.

Moreover, if the apparatus-to-be-maintained sends information after some change in the status of the apparatus-to-be-maintained has occurred, the maintaining apparatus sends a request to obtain current status of the apparatus-to-be-maintained. Accordingly, the apparatus-to-be-maintained has to send a reply to the request whenever a request is received. This increases the amount of data to be processed by the maintaining apparatus.

### SUMMARY OF THE INVENTION

An object of the invention is to provide a system in which an apparatus-to-be-maintained reads a file from a maintaining apparatus and sends information on the status of the apparatus-to-be-maintained by means of the file, so that the maintaining apparatus obtains necessary information with a minimum amount of data to be processed.

Another object of the invention is to provide a system that eliminates the need for a maintaining apparatus to send a request to an apparatus-to-be-maintained periodically and the need for the apparatus-to-be-maintained to send a reply to the request according.

An apparatus is maintained by a piece of equipment through a network. The apparatus includes a reading section and a controller. The reading section reads an instruction file from the maintaining equipment, the instruction file containing an instruction necessary for maintenance of the apparatus. The controller generates a reply in response to the instruction.

The device is the piece of equipment.

The device is an information storing server connected to the network.

The apparatus receives an update program from another device in response to the instruction.

The reading section reads the instruction file at regular time interval.

The reading section reads the instruction file at a time interval specified by the instruction file.

An apparatus maintains a piece of equipment through a network. The apparatus includes a time storing section, a clock section, a time calculating section, and a storing section. The time storing section stores a specified time. The clock section outputs a signal representative of a current time. The time calculating section calculates a difference between the current time and the specified time and writes the difference into an instruction file. The difference is calculated after the apparatus has received a request from the equipment to send an instruction file and before the instruction file is sent to the equipment. The storing section stores the instruction file.

A maintenance system includes a first apparatus and a second apparatus that is maintained by the first apparatus. The first apparatus produces an instruction file that contains time information. The second apparatus reads the instruction file from the first apparatus and reads the instruction file at a time specified by the time information when the second apparatus reads the instruction subsequently.

The first apparatus produces the time information based on a value of time information and a current time.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illustrates the configuration of a printer according to a first embodiment;

FIG. 2 illustrates the configuration of a remote maintenance system;

FIG. 3 and FIG. 4 illustrate the operations of the printer and a management server;

FIG. 5 illustrates a printer according to a second embodiment;

FIG. 6 illustrates the configuration of a remote maintenance system according to the second embodiment;

FIG. 7 is a flowchart illustrating the operation of the printer and an information storing server;

FIG. 8A illustrates an example of instruction file according to the second embodiment;

FIG. 8B illustrates the content of the instruction file written in Extensible Markup Language (XML).

FIG. 9 is a schematic view of a printer according to a third embodiment;

FIG. 10 illustrates the configuration of a remote maintenance system according to the third embodiment;

FIG. 11 is a flowchart illustrating the operation of the printer 1 and a maintenance server;

FIG. 12A illustrates an example of an instruction file according to the third embodiment;

FIG. 12B illustrates the content of the instruction file written in Extensible Markup Language (XML).

FIG. 13 illustrates a printer according to a fourth embodiment;

FIG. 14 is a flowchart illustrating the operation of the printer according to the fourth embodiment;

FIG. 15A illustrates an example of an instruction file according to the fourth embodiment;

FIG. 15B illustrates the content of the instruction file written in Extensible Markup Language (XML);

FIG. 16 illustrates the configuration of a remote maintenance system according to a fifth embodiment;

FIG. 17 is a schematic view of the management server;

FIG. 18 is a flowchart illustrating the operation of the printer according to the fifth embodiment;

FIG. 19A illustrates an example of instruction file according to the fifth embodiment;

FIG. 19B illustrates the content of the instruction file written in Extensible Markup Language (XML); and

FIG. 20 is a flowchart illustrating the operation of a management server according to the fifth embodiment.

### DETAILED DESCRIPTION OF THE INVENTION

Embodiments of the present invention will be described with reference to the accompanying drawings. By way of example, an apparatus-to-be-maintained will be described in terms of a printer. Like elements have been given like reference numerals throughout the drawings.

### FIRST EMBODIMENT

A remote maintenance system according to a first embodiment includes a maintaining apparatus and apparatuses that are to be maintained by the maintaining apparatus. A management server operates as a maintaining apparatus and, for example, printers operate as apparatuses-to-be-maintained. The management server and the printers are connected to a network. The management server incorporates a storage section that stores an instruction file. The instruction file describes the categories of information that the management server needs for maintaining the printers. The printers refer to the instruction file for the categories of information and send corresponding information to the management server over the network.

{Construction}

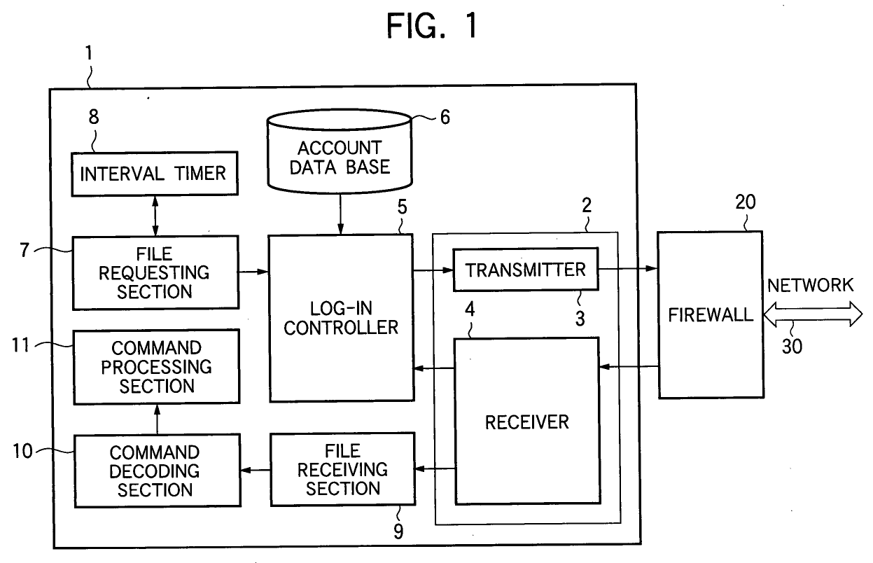

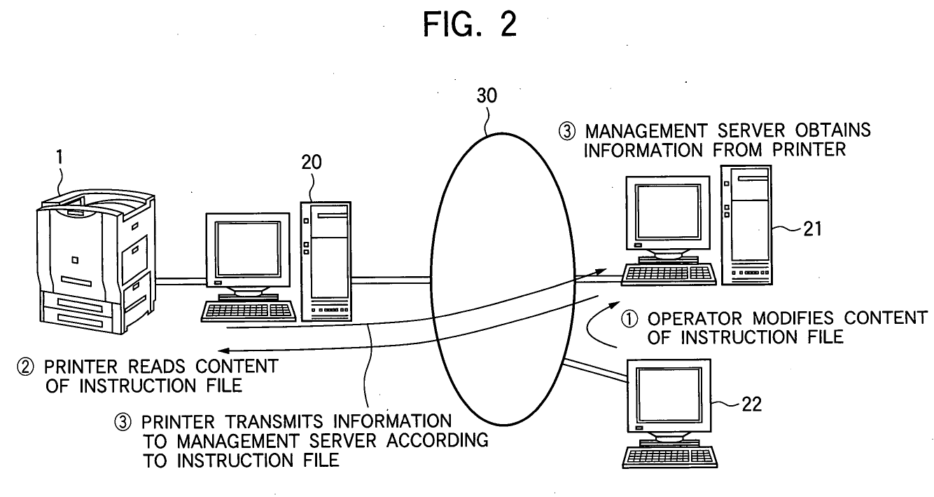

FIG. 1 illustrates the configuration of a printer according to the first embodiment. FIG. 2 illustrates the configuration of a remote maintenance system. Referring to FIG. 1, a protocol section 2 includes a transmitter 3 and a receiver 4, and performs network communications via a firewall 20, which will be described later. The transmitter 3 transmits data and a control packet to the network 30. The receiver 4 receives data and a control packet from the network 30. An account data base 6 stores authentication information therein. A log-in controller 5 obtains necessary information from the account data base 6 and sends the information to a specified server. A file requesting section 7 requests the server of transmission of the instruction file, which will be described later. An interval timer 8 outputs a signal that activates the file requesting section 7 at regular intervals. A file receiving section 9 receives the instruction file from the receiver 4. A command decoding section 10 instructs a command processing section 11 to analyze commands contained in the instruction file.

The remote maintenance system according to the first embodiment is configured as follows: Referring to FIG. 2, the printer 1 is connected to the network 30 through the firewall 20 provided for security. A maintenance terminal 22 and the management server 21 are connected to the network 30. The management server 21 stores the instruction file. The maintenance terminal 22 sets the content of the instruction file. For example, a network within a specific area such as intranet does not require security, in which case, the printer 1 may be connected directly to the network 30 rather than through the firewall 20.

{Operation}

The remote maintenance system of the aforementioned configuration operates as follows.

For remotely maintaining the printer 1 connected to the network 30 such as a LAN within a client's premises, the content of the instruction file stored in the management server 21 is altered through the maintenance terminal 22 connected to the network 30 as required, thereby setting a new specific instruction (FIG. 2, \textcircled{1}). The printer 1 accesses the management server 21 on the network 30 at regular intervals to read the instruction file stored in a memory area within the management server 21 (FIG. 2, \textcircled{2}). Then, the printer 1 transmits to the management server 21 the information on the printer 1 corresponding to the categories of information in the instruction file read from the memory area (FIG. 2, \textcircled{3}).

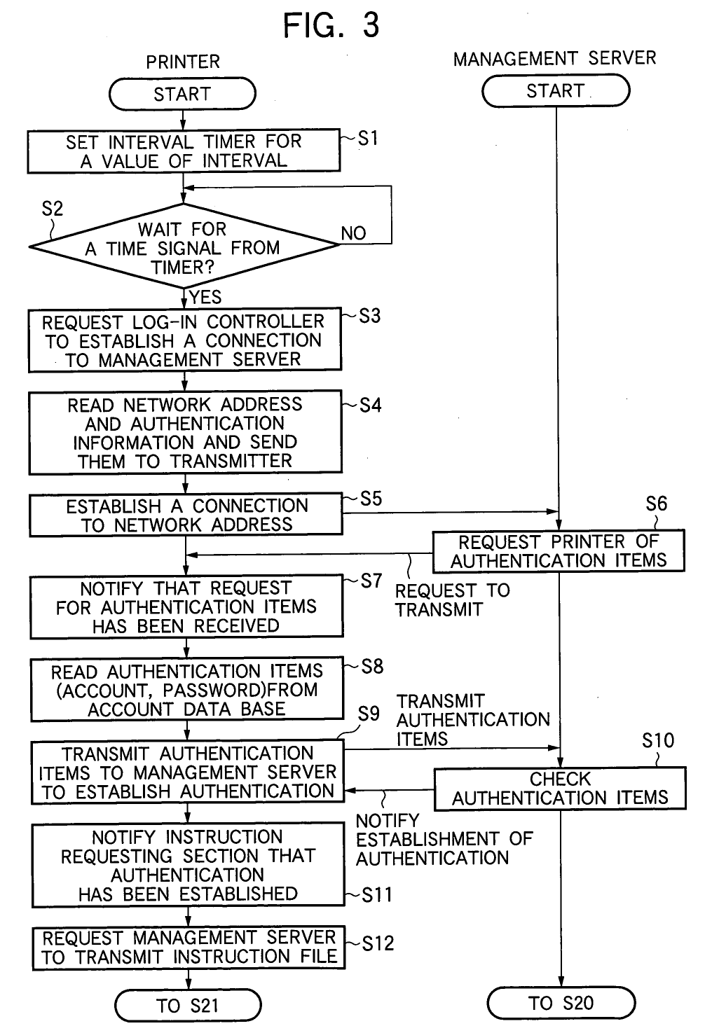

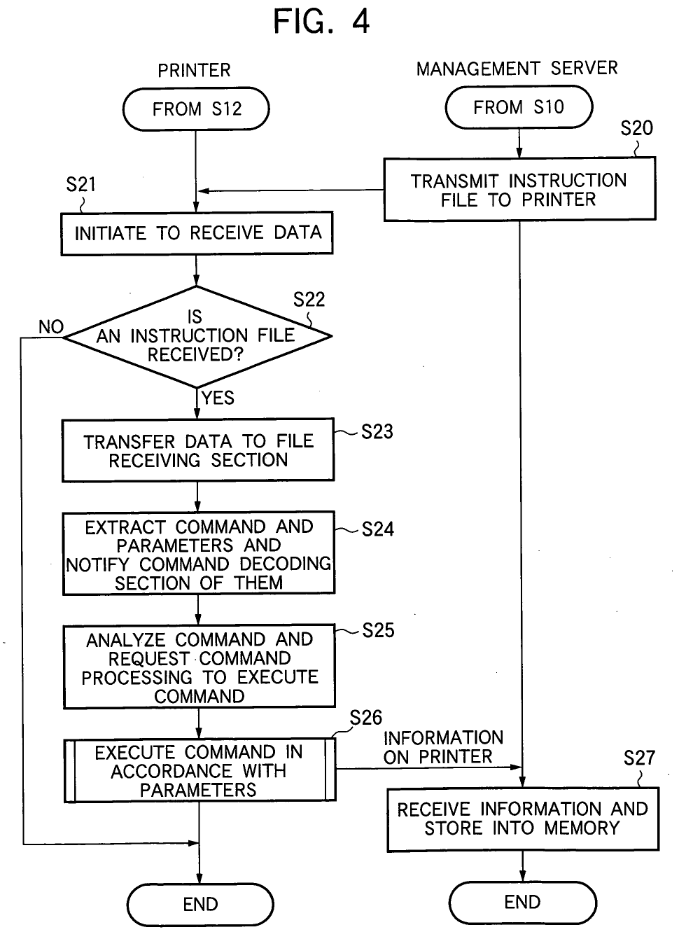

FIG. 3 and FIG. 4 illustrate the operations of the printer 1 and management server 21. The operations of the respective sections will be described in detail with reference to FIGS. 1-4.

{Operation of Maintenance Terminal}

The management server 21 holds information therein, e.g., remaining amount of a consumable item in the printer, received from the printer 1. When the operator at the maintenance terminal 22, who is maintenance personnel, wants to obtain information such as remaining amount of a consumable item in the printer, the operator operates the operation panel of the maintenance terminal 22 to establish a connection to the management server 21 via the network 30. In this manner, the operator obtains the information on the printer 1 from the management server 21.

{Connecting Printer to Management Server}

FIG. 3 is a flowchart illustrating the operation in which the printer 1 is connected to the management server 21 through the network 30.

In order to check the content of the instruction file at predetermined intervals, the file requesting section 7 in the printer 1 sets the interval timer 8 for a specific value of interval (step S1), and then waits until the interval timer 8 outputs a time signal (step S2).

Upon receiving the time signal from the interval timer 8, the file requesting section 7 requests the log-in controller 5 to establish a connection to the management server 21, notifying the log-in controller 5 of, for example, a server name that specifies the management server 21 (step S3)

In response to the request from the file requesting section 7, the log-in controller 5 searches an account data base 6 by the server name to obtain the network address and authentication information of the server necessary for establishing a connection to the server, and then sends them to the transmitter 3 (step S4).

The transmitter 3 establishes a connection to the network address received from the log-in controller 5 by means of TCP/IP network (step S5).

Once the connection between the printer 1 and the management server 21 has been established, the management server 21 initiates an authentication processing, requesting the printer 1 of authentication items (step S6).

Upon receiving the request for the authentication items from the management server 21, the receiver 4 notifies the log-in controller 5 that the request for authentication items has been received from the management server 21 (step S7).

Using the authentication information obtained from the account data base 6 at step S4, the log-in controller 5 prepares the authentication items requested from the management server 21 (step S8). The authentication information may be obtained from the account data base 6 at step S8 instead of from the account data base 6 at step S4.

Upon receiving the authentication items from the log-in controller 5, the transmitter 3 transmits the items for authentication to the management server 21, thereby establishing authentication (steps S9 and S10). Then, the log-in controller 5 notifies the file requesting section 7 that the authentication of the management server 21 has been established and therefore the instruction file can now be transmitted and received (step S11).

Upon receiving the notification that the instruction file can now be transmitted and received, the file requesting section 7 requests the management server 21 to transmit the instruction file (step S12). After step S12, upon elapse of a predetermined length of time, the interval timer 8 outputs a signal at predetermined intervals to activate an interruption process, i.e., a request for transmission of the instruction file in which steps S3-S12 are executed.

{Data Communication Between Printer and Management Server}

Upon receiving the request to transmit the instruction file from the printer 1 at step S12, the management server 21 transmits the instruction file to the printer 1 (step S20). The receiver 4 in the printer 1 in turn initiates to receive the instruction file as follows (step S21).

The receiver 4 makes a decision to determine whether a received file is the instruction file (step S22). If YES, then the program proceeds to step S23. If NO, the program ends. Alternatively, the decision may be performed in the file receiving section 9 instead of in the receiver 4.

The receiver 4 transfers the data, received from the management server 21, to the file receiving section 9 (step S23) Then, the file receiving section 9 identifies a command and parameters associated with the command that are described in the instruction file, and then notifies the command decoding section 10 of the command and the parameters (step S24).

The command decoding section 10 in turn decodes the notified command. The command decoding section 10 then notifies a command processing section 11 of the associated parameters, and requests the command processing 11 to execute the command (step S25).

Commands include a request for transmitting information on the operational status of the printer 1, a request for transmitting information on the supply level of consumable items in the printer 1, and a request for transmitting information on error states. Parameters associated with the commands are, for example, authentication information used for authentication and the network address of the management server 21 to which the information should be transmitted.

The command processing section 11 performs processing in accordance with the command and parameters received from the command decoding section 10 (step S26). For example, if a command requests to transmit the information on the supply level of consumable items and the associated parameters are the network address and authentication information, the command processing section 11 is authenticated based on the authentication information by the management server 21 located at an address specified by the parameter. Then, the command processing section 11 transmits the information on the supply level of consumable items to the management server 21.

The management server 21 receives the information from the printer 1 and stores the received information into the memory, thus completing the process (step S27). When the management server 21 receives a request for transmission of information from the maintenance terminal 22 at regular intervals or when the maintenance personnel operates the maintenance terminal 22 to request for transmission of information, the management server 21 transmits all or part of the information, received from the printer 1, to the maintenance terminal 22.

The remote maintenance system according to the first embodiment is configured such that the printer 1 automatically obtains the instruction file from the management server 21 and sends required information to the management server 21. The maintenance personnel or operator needs only to operate the maintenance terminal 22 to obtain desired items of information from a plurality of printers 1. The first embodiment eliminates operator's explicit key operations every time the operator wants to obtain some information on the printer, preventing possible errors in key operations.

### SECOND EMBODIMENT

A second embodiment has a feature that an instruction file stored in a management server 21 is used to specify a communication procedure and a destination to which a printer sends its information.

{Configuration}

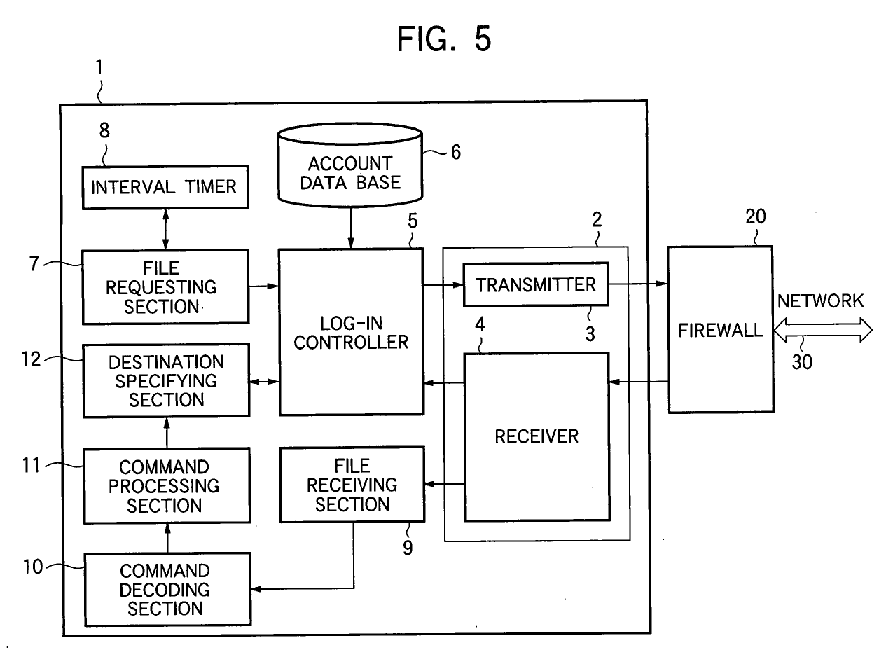

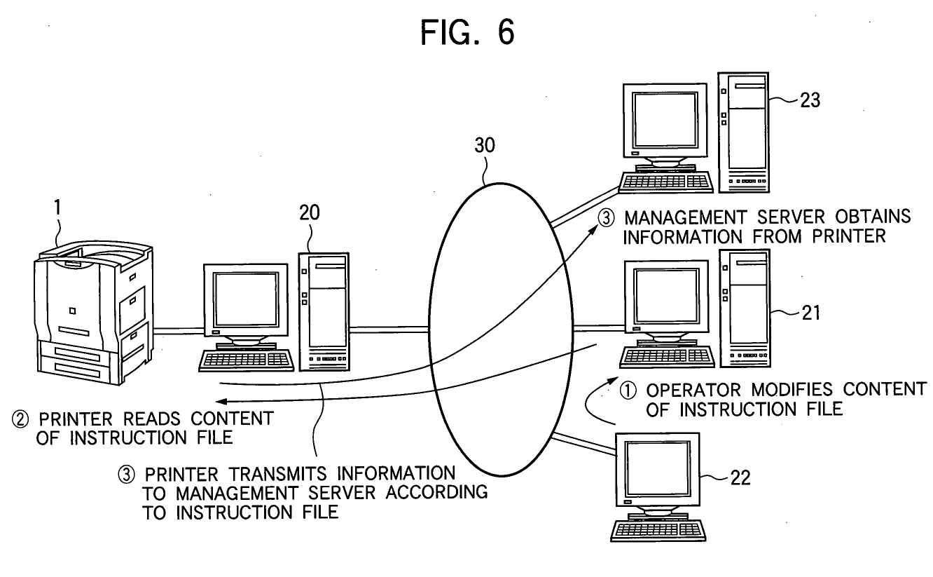

FIG. 5 is a schematic view of the printer 1 according to the second embodiment. FIG. 6 illustrates the configuration of the remote maintenance system. The second embodiment is configured such that a destination specifying section 23 is added to the configuration of the first embodiment in FIG. 5. The destination specifying section 23 stores various items of information that are based on the instruction file and are specified by the destination specifying section 12. The destination specifying section 23 operates to transmit the various items of information to a destination specified by the instruction file. The remaining portion of the second embodiment is the same as that of the first embodiment and the description thereof is omitted.

{Operation}

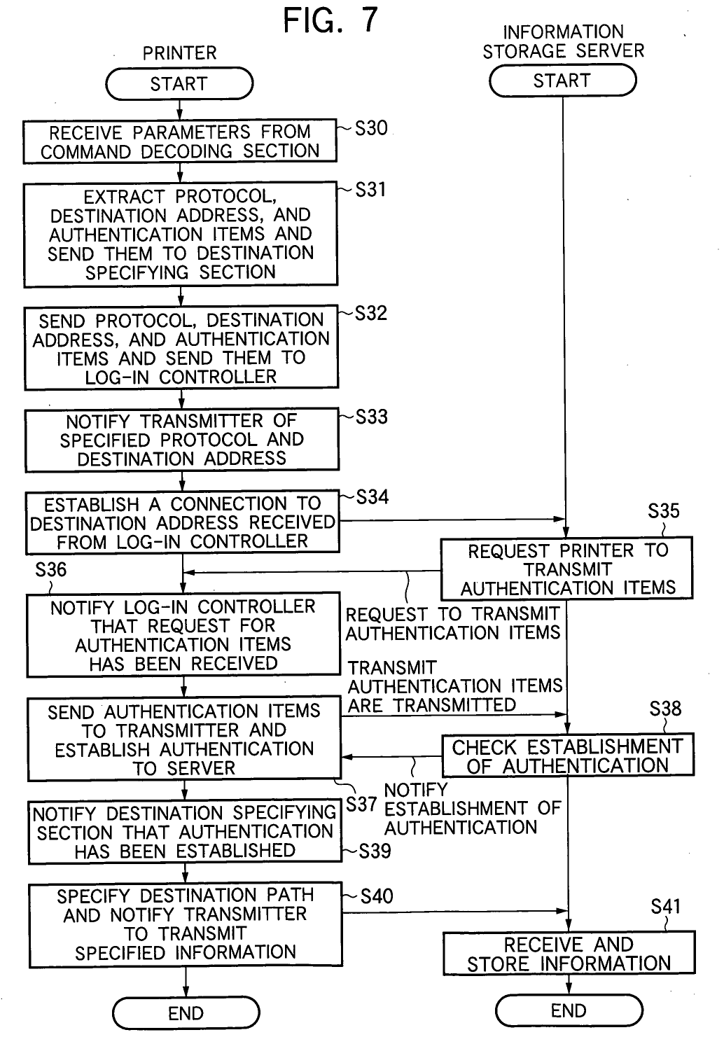

The remote maintenance system of the aforementioned configuration operates as follows. The remote maintenance system remotely maintains the printer 1 connected to a network 30 such as a client's LAN. Referring to FIG. 6, whenever it is necessary, the operator performs key operations of the maintenance terminal 22 connected to a network 30 in order to modify the content of an instruction file in the management server 21 (FIG. 6, \textcircled{1}). The printer 1 accesses the management server 21 on the network 30 at regular intervals to read the instruction file stored in a memory of the management server 21 (FIG. 6, \textcircled{2}). Then, the information on the printer 1 is transmitted to the information storing server 23 in accordance with the content of the thus read instruction file (FIG. 6, \textcircled{3}) FIG. 7 is a flowchart illustrating the operation of the printer 1 and information storing server 23. The operations of the respective sections will be described in detail with reference to FIG. 5, FIG. 6, and FIG. 7.

{Operation of the Maintenance Terminal}

The information storing server 23 holds information on the printer 1, e.g., remaining amount of a consumable item in the printer, received from the printer 1. When the operator at the maintenance terminal 22, who is maintenance personnel, wants to obtain information such as remaining amount of a consumable item in the printer 1, the operator operates the operation panel of the maintenance terminal 22 to input an information item (e.g., remaining amount of a consumable item), a destination address (i.e., information storing server 23), a destination path into which the information from the printer 1 should be stored, and authentication items. Then, the maintenance terminal 22 establishes a connection to the information storing server 23 to access the destination path (i.e., “/public/pr/usr200”) of the information storing server 23. In this manner, the operator obtains the information on the printer 1 from the information storing server 23.

{Connecting between Printer and Management Server}

The printer 1 and management server 21 operate in the same way as the first embodiment in FIG. 3. Additionally, the operation from step S20 where the instruction file is transmitted from the management server 21 to step S25 where the command decoding section 10 in the printer 1 processes commands is the same as the first embodiment. Thus, the detailed description of the connection between the printer and management server 21 is omitted.

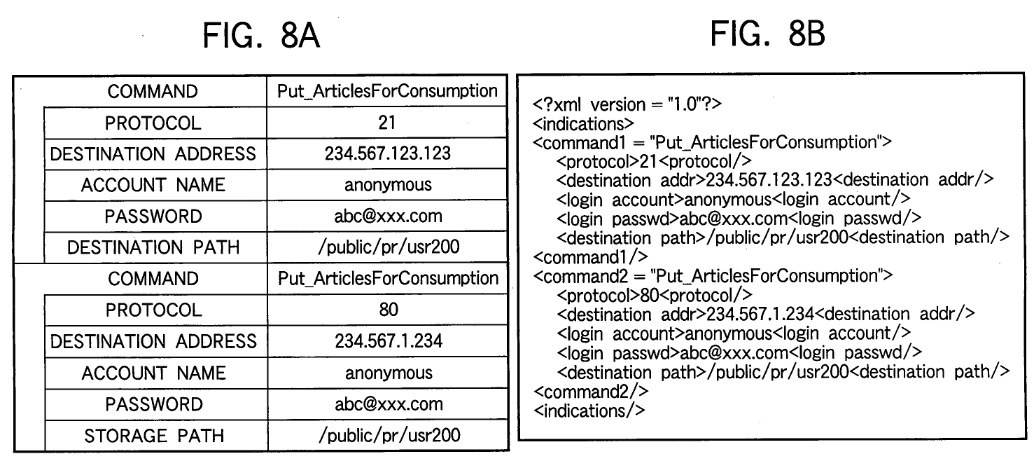

A description will be given of the operation of the command processing section 11 when the instruction file in FIGS. 8A and 8B contains information on the supply level of consumable items and is transmitted to the information storing server 23.

{Structure of Instruction File}

FIG. 8A illustrates an example of instruction file according to the second embodiment. FIG. 8B illustrates the content of the instruction file written in Extensible Markup Language (XML). As is clear from FIGS. 8A and 8B, the instruction file may contain a plurality of commands. Parameters associated with the respective commands are, for example, authentication items such as a protocol, an account name, a password, and a destination path into which the information is to be stored.

{Operation of Command Processing Section}

After having been connected to the management server 21 (steps S1-S12 in FIG. 3), the printer 1 obtains the instruction file in FIG. 8B from the management server 21 (steps S20-S25 in FIG. 4).

Then, the command processing section 11 obtains a command to transmit information on the supply level of consumable items and the parameters associated with the command, which are extracted from the content of the instruction file by the command decoding section 10 (step S30). Then, the command processing section 11 extracts, for example, a protocol, a destination address to which the information on the supply levels of consumable items should be transmitted, and a destination path into which the information is to be stored, and notifies the destination specifying section 12 of the extracted protocol, destination address, and destination path (step S31).

With the example of instruction file in FIGS. 8A and 8B, for example, “command 1” specifies “Put_ArticlesForConsumption” is described. The command decoding section 10 decodes this command as commanding transmission of information on the supply level of consumable items. Then, the associated parameters following the command are extracted and sent to the command processing section 11.

Another “command 2” also specifies “Put_ArticlesForConsumption.” Parameters associated with the “command 2” are also extracted and sent to the command processing section 11. In response to the command received from the command decoding section 10, the command processing section 11 activates a processing for transmitting the information on the supply level of consumable items, and analyzes the parameters as follows:

The “protocol” under which connection is made is denoted by “21” and “80”. Thus, they are interpreted as file transfer protocol (FTP) and hyper text transfer protocol (HTTP), respectively, according to the definition in TCP/IP.

There are also described “destination addr”, which is a destination address to which the information is to be transmitted. The “destination addr” is an IP address varying from command to command. Thus, it is determined that the information on the supply level of consumable items should be sent to two different servers. Both command 1 and command 2 commonly have “anonymous” as an account name “login account” and “abc@xxx.com” for “login passwd.” Thus, it is determined that connections should be made to an information storing server at IP address 234.567.123.123 and an information storing server at IP address 234.567.1.234 by using the same account name “anonymous” and the same password abc@xxx.com.

As described above, the password is the same E-MAIL address for the two commands in the present example, in which case, the E-MAIL is recorded as a log. When a failure occurs, this log as a record of access is used in analyzing the failure. The log is also used in compiling information. The log is further used when information should be sent from the respective servers or the maintenance terminal 22 to the printer 1.

The both command 1 and command 2 have “/public/pr/user200” as a destination path “destination path” into which the information on the supply level of consumable items is to be stored. Thus, it is determined that the information on the supply level of consumable items should be stored into “/public/pr/user200” folder of the respective servers.

In order to establish a connection to the information storing server 23 specified by the instruction file, the destination specifying section 12 notifies the log-in controller 5 of the protocol, destination address, and authentication items (step S32). In response to the notification, the log-in controller 5 notifies the transmitter 3 of the specified protocol and destination address (step S33).

Then, the transmitter 3 establishes a connection to the destination address received from the log-in controller 5 according to TCP/IP (step S34). The information storing server 23 of the destination address requests authentication items (account name, password, etc.) for performing authentication (step S35).

Upon receiving a request for authentication items from the information storing server 23, the receiver 4 notifies the log-in controller 5 that the request for authentication items has been received (step S36). The log-in controller 5 transmits the authentication items to the transmitter 3, thereby establishing authentication between the information storing server 23 (steps S37 and S38), and notifies the destination specifying section 12 that authentication (hence a connection) has been established (step S39).

The destination specifying section 12 specifies the destination path (“public/pr/usr200” for “destination path” in FIG. 8B) into which the information on the supply level of consumable items is stored, then notifies the transmitter 3 of the information on the supply level of consumable items (step S40), and finally stores the information on the supply level of consumable items into the folder of the information storing server 23 (step S41).

In the example in FIG. 8, each of the two commands specifies the information on the supply level of consumable items to be stored into a corresponding one of two information storing servers 23. Thus, the operation from step S32 to step S41 is performed for each of the two information storing servers 23.

According to the second embodiment, the remote maintenance system is equipped with the destination specifying section 12. Providing the destination specifying section 12 allows a printer to send the information on the printer to a plurality of information-storing servers as well as to the management server 21. This configuration provides the same advantages as the first embodiment, and additionally permits simultaneous establishing of connection to a plurality of servers according to a desired protocol. Thus, desired information on the printer can be stored into a desired directory.

### THIRD EMBODIMENT

A remote maintenance system according to a third embodiment permits specifying of a communication procedure, a destination to which information on a printer is sent, a server from which an update program is obtained via the instruction file in a management server. The communication procedure, destination, and server may be specified for individual printers depending on the area or market for which the printers are destined.

{Configuration}

The printer according to the third embodiment has the same configuration as the first embodiment and an additional configuration, i.e., a destination data base 13, an updated file requesting section 14, and an updating section 15. The destination data base 13 stores the destinations of the printer for which the printer is shipped. The updated file requesting section 14 receives a request for an update program from the maintenance server 24, the request being based on the data in the destination data base 13. The updating section 15 updates a control program of the printer 1 in accordance with the update program received from the maintenance server 24. The maintenance server 24 stores the update program corresponding to the place of destination for which the printer 1 is destined. The remaining part of the configuration of the printer 1 is the same as that of the first embodiment and the description thereof is omitted.

The remote maintenance system according to the third embodiment is configured in such a way that the maintenance server 24 is connected to a network 30 in the configuration of the first embodiment. The remaining part of the configuration of the remote maintenance system is the same as that of the first embodiment and the description thereof is omitted. Alternatively, the remote maintenance system according to the third embodiment may be configured in such a manner that the maintenance server 24 is added to the remote maintenance system (FIG. 6) having an information storing server 23. Still alternatively, the management server may have functions of a maintenance server instead of providing a maintenance server.

The update program is a program used to update, for example, control programs of the printer 1 for improving functions or solving trouble occurred in the printer 1.

The file size of an update program is usually larger than several tens mega bytes. Thus, if the management server 21 is at a place distant from the printer 1 and a desired update program is to be downloaded from the management server 21 for updating the control program of the printer 1, the time required for downloading the update program is not negligible. Further, when a management server 21 is located in a foreign country, information such as the control program and font data should be changed according to the language in that country. Thus, the update program often varies from country to country. For these reasons, the remote maintenance system according to the third embodiment is configured such that the update program can be loaded from the maintenance server 24 located at a place for which the printer is destined, i.e., the geographical area in which the printer is sold.

{Operation}

The remote maintenance system of the aforementioned configuration according to the third embodiment operates as follows:

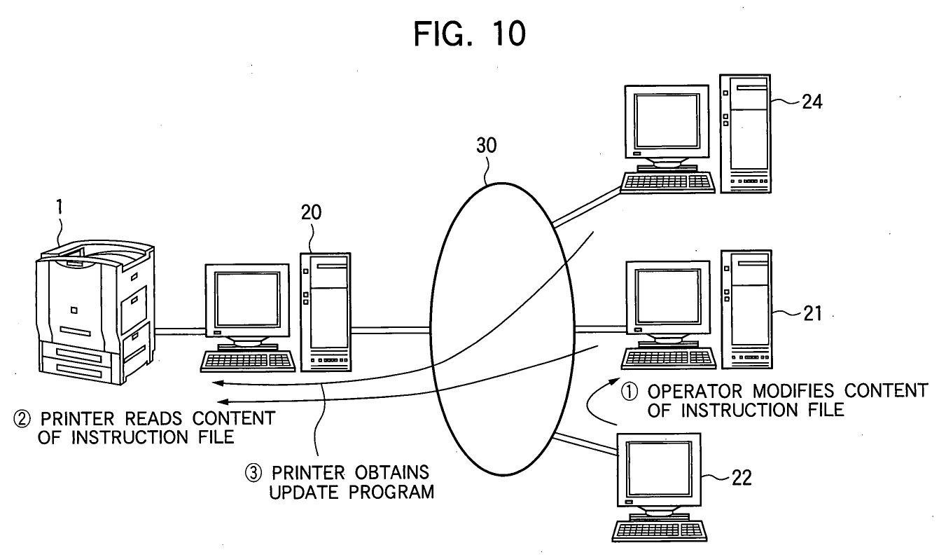

The remote maintenance system remotely maintains the printer 1 connected to a network 30 such as a client's LAN. Referring to FIG. 6, whenever it is necessary, the operator performs key operations of the maintenance terminal 22 connected to a network 30 in order to modify the content of an instruction file in the management server 21 (FIG. 10, \textcircled{1}). The printer 1 accesses the management server 21 on the network 30 at regular intervals to read the instruction file stored in a memory of the management server 21 (FIG. 10, \textcircled{2}). Then, the information on the printer 1 is transmitted to the management server 21 in accordance with the content of the thus read instruction file. Then, the printer obtains the update program from the maintenance server 24 (FIG. 10, \textcircled{3}).

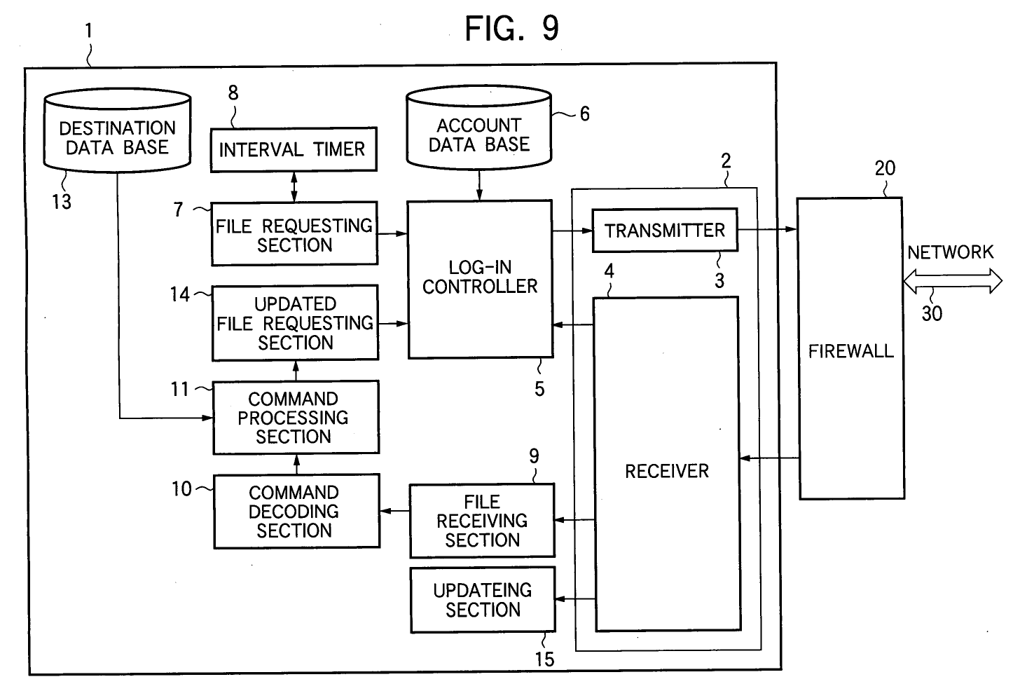

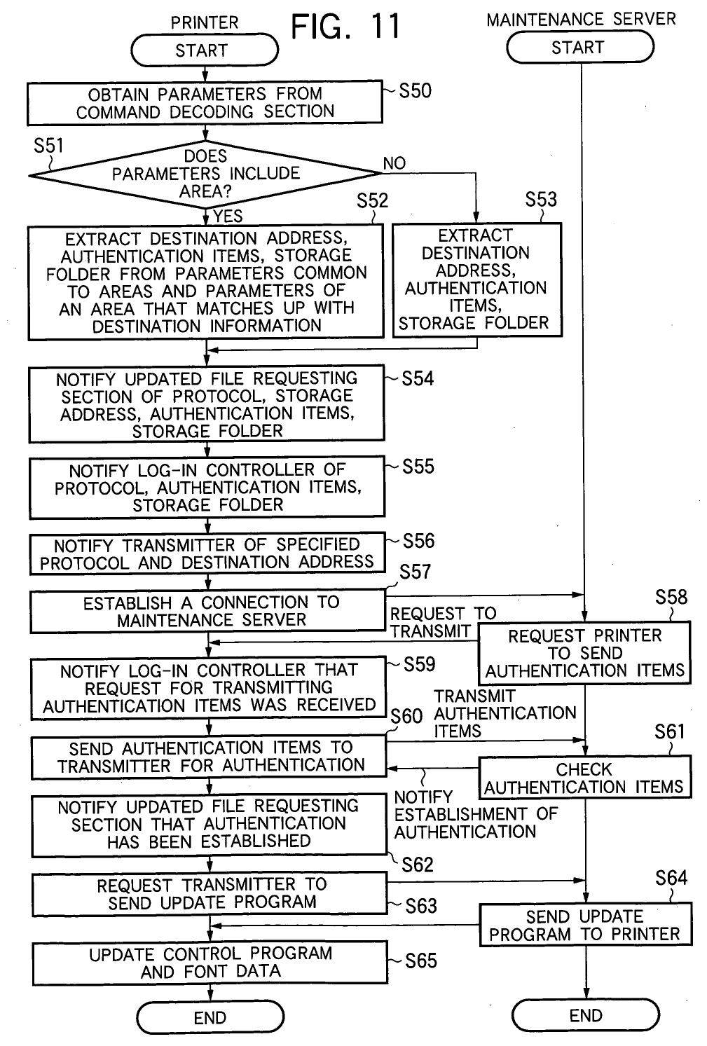

FIG. 9 is a schematic view of the printer. FIG. 10 illustrates the configuration of the remote maintenance system. FIG. 11 is a flowchart illustrating the operation of the printer 1 and maintenance server 24.

{Operation of the Maintenance Terminal}

When the operator at the maintenance terminal 22, who is maintenance personnel, wants to obtain information such as a remaining amount of a consumable item in the printer and information on the most recent update program, the operator operates the operation panel of the maintenance terminal 22 to input an information item (e.g., remaining amount of a consumable item) and request for the information on the most recent update program. Then, a connection to the management server 21 is established. Subsequently, the instruction file in the server is modified in accordance with the information items that the operator input through the maintenance terminal 22.

{Connecting Between Printer and Management Server}

The printer and management server operate in the same way as the first embodiment in FIG. 3. Additionally, the operation from step S20 where the instruction file is transmitted from the management server 21 to step S25 where the command decoding section 10 in the printer 1 processes commands is the same as the first embodiment. Thus, the detailed description of the connection between the printer and management server is omitted.

{Structure of Instruction File}

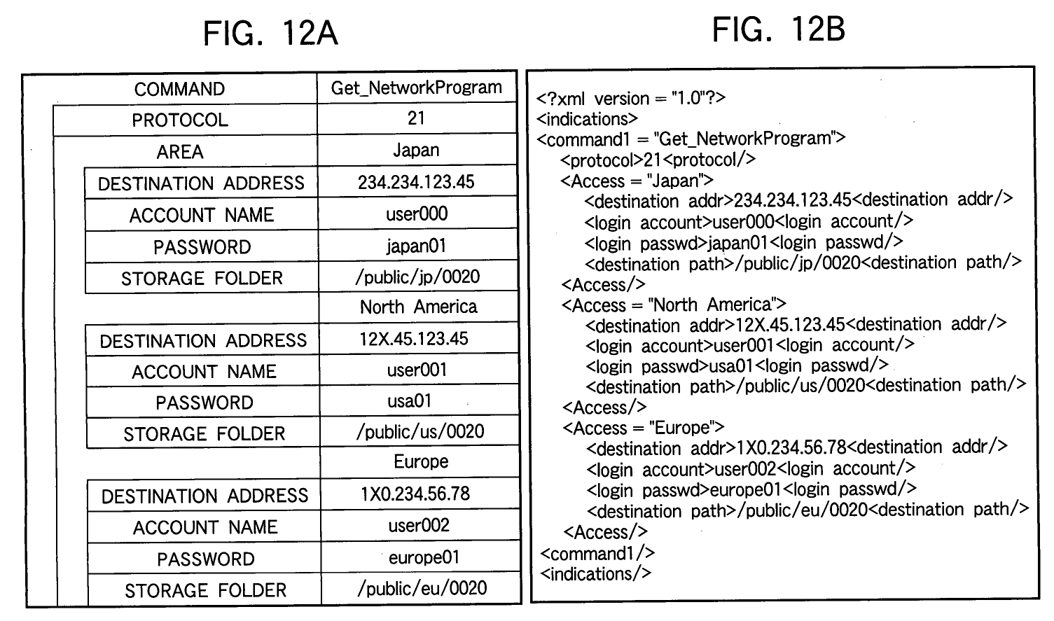

FIG. 12A illustrates an example of an instruction file according to the third embodiment. FIG. 12B illustrates the content of the instruction file written in Extensible Markup Language (XML). The instruction file is such that one command has its associated parameters.

Referring to FIG. 12B, “command 1” for updating, for example, a control program in the printer 1 is “Get_NetworkProgram” and has a protocol as an associated parameter. Areas to be accessed include Japan, North America, and Europe. Each area is an assigned destination address that indicates an address of a maintenance server 24 at a corresponding destination, an account name and a password that are used for authentication, a storage folder in which the update program is stored. If maintenance is to be carried out for only a limited area, then the area need not be specified. Instead, the parameter may include one protocol, a destination address, an account name, a pass word, and a storage folder. Instead of grouping areas into those in FIG. 12, areas may be specified on a country-by-country basis or by smaller regions within each country.

{Operation of Command Processing Section}

After having been connected to the management server 21 (steps S1-S12 in FIG. 3), the printer 1 obtains the instruction file in FIG. 12B from the management server 21 (steps S20-S25 in FIG. 4).

Then, the command processing section 11 obtains a command “program update command” and associated parameters, the command and associated parameters being decoded from the description in the instruction file in FIG. 12B by the command decoding section 10 (step S50). Then, the command processing section 11 initiates a processing for updating the control program of the printer 1 (referred to as “updating processing” hereinafter) to determine whether the associated parameters include an area (step S51). If the associated parameters include an area, the program proceeds to step S52.

In other words, in the update processing performed by the command processing section 11, destination information or area for which the printer is destined is read from the destination data base 13. Then, an area that corresponds to the destination information is retrieved from the instruction file, thereby extracting the destination address, authentication items (account name, password), and storage folder from the parameters that correspond to the destination information (step S52)

For destination information “North America” in the instruction file in FIG. 12, <Access=“North America”> that describes an area is retrieved. Then, an IP address 12X.45.123.45 of the maintenance server 24 is extracted from “destination addr>12X.45.123.45<destination addr/>”. An authentication ID “user001” is extracted from “<login account>user001<login account/>”. An authentication password “usa01” is extracted from “<login passwd>usa01<login passwd/>”. A storage folder “/public/us/0020” is extracted from “<destination path>/public/us/0020<destination path/>”.

It is common to all areas that a protocol is “21” and communication is performed in FTP. This is extracted from “<protocol>21<protocol/>” that is common to all areas.

If it is determined at step S51 that an area is not described in the obtained parameters, then a protocol, a destination address, authentication items (account name, password), and a storage folder, which are parameters common to all areas, are extracted (step S53). If the obtained parameters contain area information but the area information does not match up with the destination of the printer, it is preferable to notify the management server 21.

Then, extracted protocol, destination address, target source path, authentication items (account name, password) are sent to the updated file requesting section 14, thereby requesting the updated file requesting section to obtain an update file (step S54).

Then, the update file requesting section 14 notifies the log-in controller 5 of the protocol, destination address, and authentication items in order to establish a connection with the maintenance server 24 that holds the update program (step S55). The log-in controller 5 sends the specified protocol and destination address to the transmitter (step S56). Then, the transmitter 3 establishes a connection with the maintenance server 24 at the destination address notified from the log-in controller 5 (step S57).

After establishing the connection, the maintenance server 24 at the destination requests the printer 1 to send authentication items (account name, password) in order to perform authentication (step S58). Upon receiving a request for transmitting authentication items from the maintenance server 24, the receiver 4 notifies the log-in controller 5 that the request for transmitting authentication items was received from the maintenance server 24 (step S59). Then, the log-in controller 5 sends the authentication items to the transmitter 3 for performing authentication between the maintenance server 24 (steps S60 and S61) and then notifies the updated file requesting section 14 that the authentication has been established (step S62).

By specifying a folder that holds the update program, the updated file requesting section 14 sends to the transmitter 3 a request for sending the update program (step S63). The transmitter 3 transmits the request for sending the update program stored in the specified storage folder. The maintenance server 24 receives the request and sends the update program, stored in the specified storage folder, to the printer 1 (step S64). This completes the processing on the server side.

The printer 1 receives the update program from the maintenance server 24 via the receiver 4 and then updates, for example, the control program and font data by using the update program (step S65). This completes the processing on the updating processing.

As described above, by means of the instruction file stored in the management server, a server from which the update program is obtained, destination to which information is transmitted, and communication procedure may be specified on a printer-by-printer basis. Thus, the third embodiment provides the following advantages as well as those of the first and second embodiments.

Connection can be made to a maintenance server at a short distance. This reduces the chance of congestion due to errors in the communication line and shortens the time required for updating programs, thereby decreasing the burden of the maintenance server.

Files to be updated such as programs and fonts vary from area to area. These files to be updated can be downloaded reliably.

### FOURTH EMBODIMENT

A remote maintenance system according to a fourth embodiment is such that intervals (referred to as “file-read interval” hereinafter) at which an instruction file stored in a management server is read can be specified depending on the area at which the printer is located. In other words, the file-read interval may be specified according to, for example, the area for which the printer is destined. The fourth embodiment will be described in terms of an area for which the printer is destined.

{Configuration}

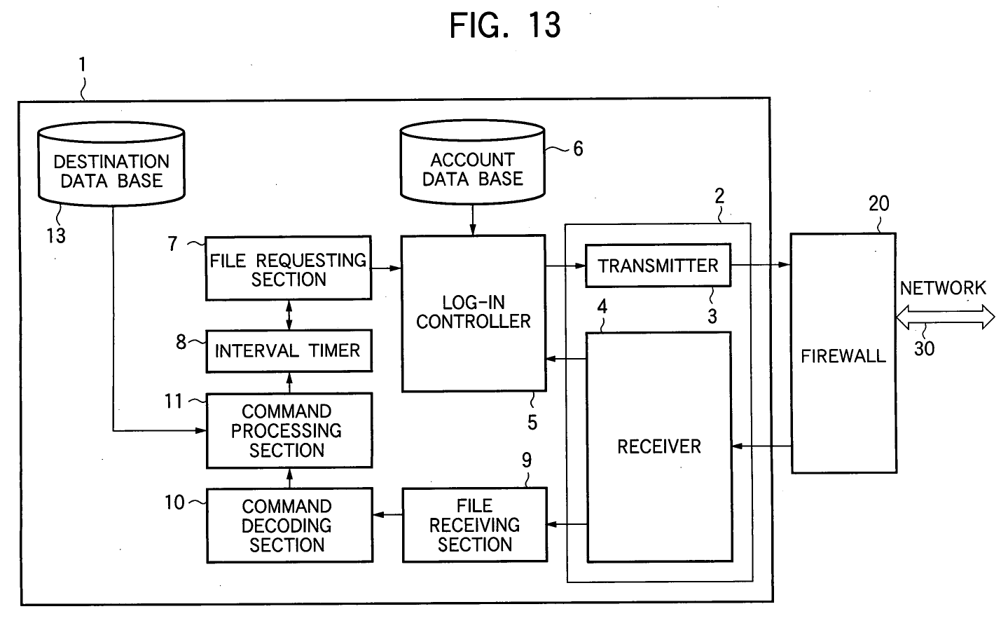

FIG. 13 illustrates a printer 1 according to the fourth embodiment configured such that a destination data base 13 is added to the configuration of the first embodiment. The destination data base 13 stores the place for which the printer is to be destined. The destination data base 13 is connected to the command processing section 11, and the command processing section 11 is connected to the interval timer 8. The instruction file contains the file-read interval. The command decoding section 10 and command processing section 11 cooperate with each other to extract the file-read interval from the content of the instruction file. The remaining configuration is the same as that of the first embodiment in FIG. 1 and the description thereof is omitted.

The configuration of the remote maintenance system according to the fourth embodiment is the same as that of the first embodiment in FIG. 2 and therefore the detailed description thereof is omitted. Alternatively, the remote maintenance system may be those in FIGS. 6 and 10.

{Operation}

The remote maintenance system according to the fourth embodiment will operate as follows.

The remote maintenance system remotely maintains the printer 1 connected to a network 30 such as a client's LAN.

Referring to FIG. 2, whenever it is necessary, the operator operates a maintenance terminal 22 connected to a network 30 so as to alter the content of an instruction file in the management server 21 (FIG. 2, \textcircled{1}). The printer 1 accesses the management server 21 on the network 30 to read the instruction file stored in a memory of the management server 21, the access being made at the file-read interval contained in the instruction file (FIG. 2, \textcircled{2}). Then, the information on the printer 1 is transmitted to the management server 21 according to the content of the thus read instruction file (FIG. 2, \textcircled{3}).

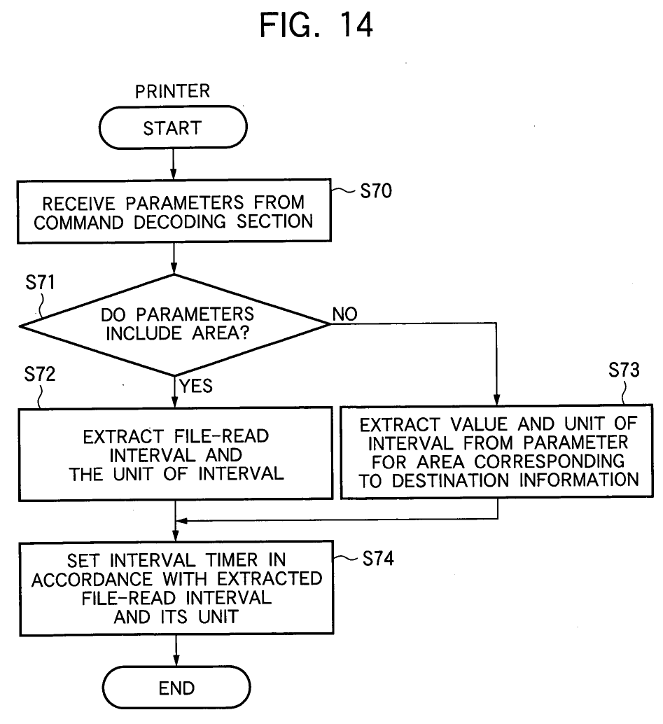

FIG. 13 is a schematic view of the printer 1. FIG. 2 illustrates the configuration of the remote maintenance system. FIG. 14 is a flowchart illustrating the operation of the printer 1. The operations of respective sections will be described in detail with reference to FIG. 13, FIG. 2, and FIG. 14.

{Operation of the Maintenance Terminal}

When the operator at the maintenance terminal 22, who is maintenance personnel, wants to obtain information such as a remaining amount of a consumable item in the printer and the file-read interval according to an area for which the printer is destined, the operator operates the operation panel of the maintenance terminal 22 to input an information item (e.g., remaining amount of a consumable item) and request for the information on the file-read interval. Then, a connection to the management server 21 is established. Subsequently, the instruction file in the management server 21 is modified in accordance with the information that the operator input through the maintenance terminal 22.

{Connecting Between Printer and Management Server}

The connection between the printer and management server is performed in the same way as the first embodiment in FIG. 3. Additionally, the operation from step S20 where the instruction file is transmitted from the management server 21 to step S25 where the command decoding section 10 in the printer 1 processes commands is the same as the first embodiment. Thus, the detailed description of the connection between the printer and management server is omitted.

{Structure of Instruction File}

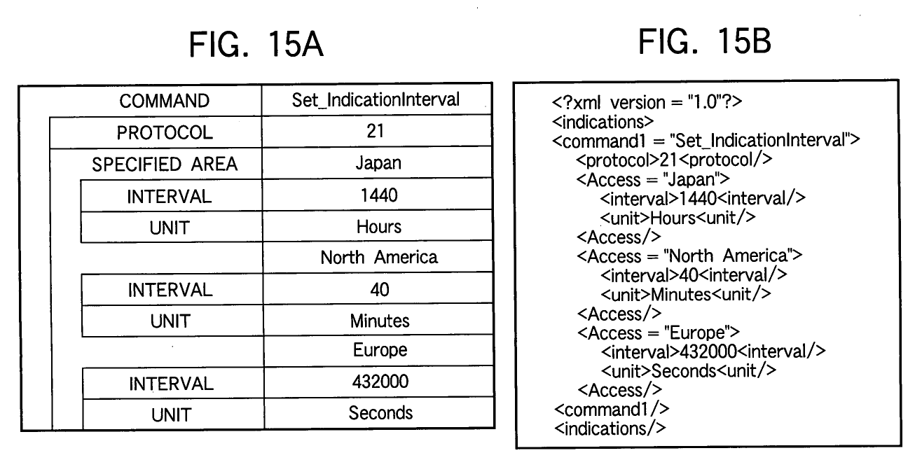

FIG. 15A illustrates an example of the instruction file according to the fourth embodiment. FIG. 15B illustrates the content of the instruction file written in Extensible Markup Language (XML). This instruction file is such that one command has its associated parameters.

Referring to FIGS. 15A and 15B, “Set_IndicationInterval” describes the command for setting a file-read interval and has a protocol as an associated parameter. Areas to be accessed include Japan, North America, and Europe. Each area is assigned a file-read interval, and the unit of the file-read interval.

File-read interval is the time interval at which the printer 1 obtains the instruction file. The interval can be set in unit of, for example, hours, minutes, or seconds. Generally, the instruction file is preferably readily understood visually. A long file-read interval should be set in unit of hours while a short file-read interval should be set in unit of seconds.

If maintenance is to be carried out for only a limited area, then the area need not be specified. Instead, the parameter may include one protocol, one file-read interval, and one unit of the file-read interval. Instead of grouping areas into those in FIGS. 15A and 15B, areas may be specified on a country-by-country basis or in terms of smaller regions within each country.

{Operation of Command Processing Section}

After having been connected to the management server 21 (steps S1-S12 in FIG. 3), the printer 1 obtains the instruction file in FIG. 15B from the management server 21 (steps S20-S25 in FIG. 4).

Then, the command processing section 11 obtains a command “read interval modifying command” and associated parameters, the command and associated parameters being decoded from the description in the instruction file in FIG. 15B by the command decoding section 10 (step S70). Then, the command processing section 11 initiates a processing for modifying file-read interval (referred to as “read interval modifying processing” hereinafter) to determine whether the associated parameters include an area or areas (step S71). If the associated parameters include an area, the program proceeds to step S72.

In other words, in the read interval modifying processing performed by the command processing section 11, the destination information on the printer 1 is read from the destination data base 13 and an area that corresponds to the destination information is retrieved from the instruction file, thereby extracting the file-read interval and the unit of the file-read interval for the area corresponding to the destination information (step S72).

For destination information “Japan” in the instruction file in FIG. 15B, “<Access=“Japan”>” is retrieved. Then, an instruction file read interval “1440 hours” is extracted from the description “<interval>1440<interval/>” and the description “<unit>Hours<unit/>”.

It is common to all areas that a protocol is “21” and communication is performed in FTP. This is extracted from “<protocol>21<protocol/>”.

If it is determined at step S71 that an area is not described in the obtained parameter, then a protocol, a file-read interval, and a unit of the file-read interval are extracted (step S73). If the obtained parameters contain area information but the area information does not match up with any destination, it is preferable to notify the management server 21.

The command processing section 11 performs the read interval modifying processing” to set the interval timer 8 in accordance with the extracted file-read interval and the unit of the file-read interval (step S74).

As described above, in order to modify the file-read interval on a destination-by-destination basis, it is only necessary to change the content of the instruction file at the maintenance terminal 22.

The remote maintenance system according to the fourth embodiment has been described with respect to a case in which the file-read interval can be specified on a destination-by-destination basis. Instead, the instruction file read interval may be specified for individual printers 1, e.g., on a model-by-model basis.

Because the file-read interval can be specified for individual printers 1 by modifying the instruction file stored in the management server, the fourth embodiment provides the following advantages as well as those of the first to third embodiments.

File-read intervals can be set appropriately in accordance with the network environment of individual areas. For example, the file-read interval may be short in areas with a good network environment and may be long in areas with a poor network environment.

The burden of the management server varies depending on the number of printers to be managed. In the fourth embodiment, the file-read interval may be modified depending on the number of printers so that the burden of the management server is substantially constant.

### FIFTH EMBODIMENT

A remote maintenance system according to a fifth embodiment has a feature that the time of day at which a printer reads an instruction file may be specified through the instruction file stored in a management server. The time of day at which a printer reads an instruction file can also be set on an area-by-area basis. A description will be given in terms of destination information as area information.

{Configuration}

A printer according to the fifth embodiment has the same configuration as the fourth embodiment in FIG. 13 and the detailed description thereof is omitted. Also, the remote maintenance system according to the fifth embodiment has the same configuration as the second embodiment in FIG. 6 and the detailed description thereof is omitted.

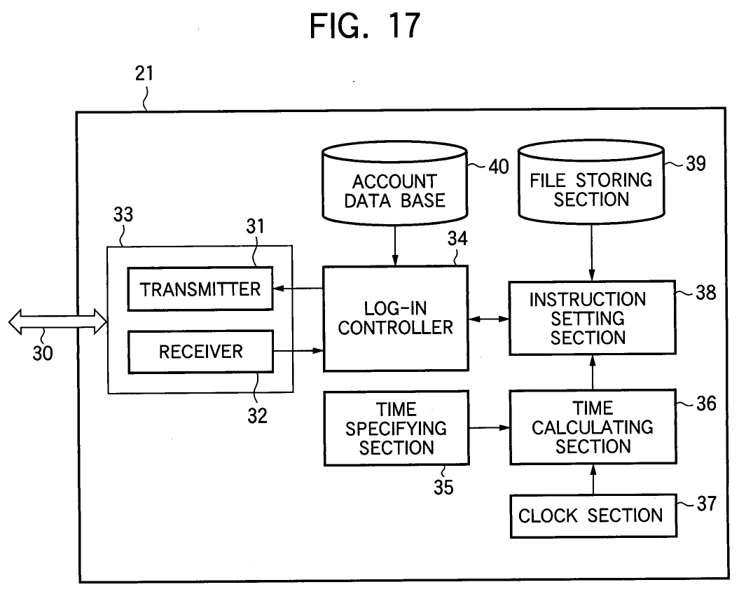

Referring to FIG. 17, network communications are performed through a protocol section 33. A transmitter 31 is part of the protocol section 33 and transmits data and control packet to the network 30. A receiver 32 receives data and control packets from the network 30. An account data base 40 holds authentication information therein. A log-in controller 34 obtains necessary information from an account data base 40, and establishes a connection to a printer that requested of the connection. A file storage section 39 stores an instruction file that instructs the printer 1. A file setting section 38 sets the content of the instruction file. A time-of-day specifying section 35 specifies the time-of-day at which the printer reads the instruction file. A clock section 37 outputs information on the current time. A time calculating section 36 calculates the difference between the current time and the time specified by the time-of-day specifying section 35.

{Operation}

The operation of the remote maintenance system according to the fifth embodiment will be described.

The remote maintenance system remotely maintains the printer 1 connected to a network 30 such as a client's LAN.

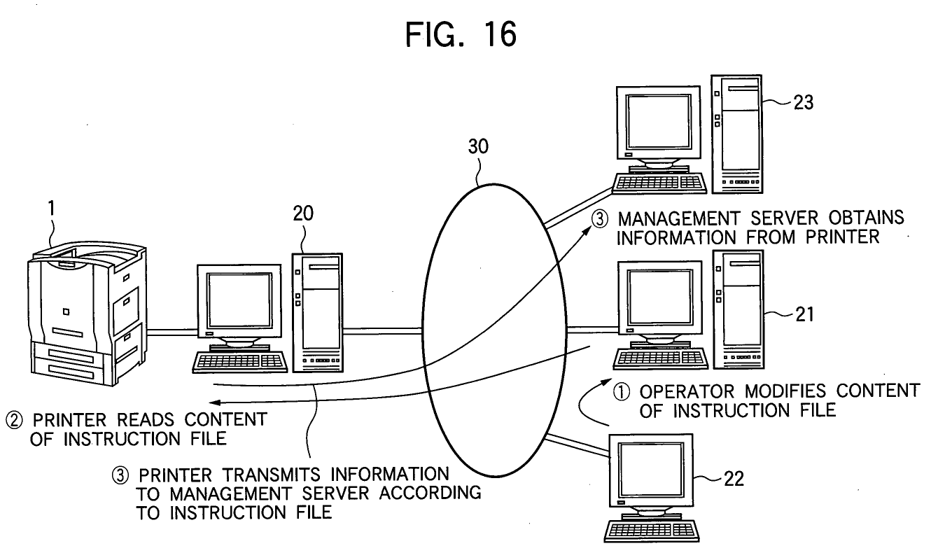

FIG. 16 illustrates the configuration of the remote maintenance system.

Referring to FIG. 16, whenever it is necessary, the operator accesses a maintenance terminal 22 connected to a network 30 so as to alter the content of an instruction file in the management server 21 (FIG. 16, \textcircled{1}). The printer 1 accesses the management server 21 on the network 30 at intervals specified by the instruction file, thereby reading the instruction file stored in a memory of the management server 21 (FIG. 16, \textcircled{2}). Then, the printer 1 transmits the information on the printer 1 to the management server 21 in accordance with the content of the thus read instruction file (FIG. 16, \textcircled{3}).

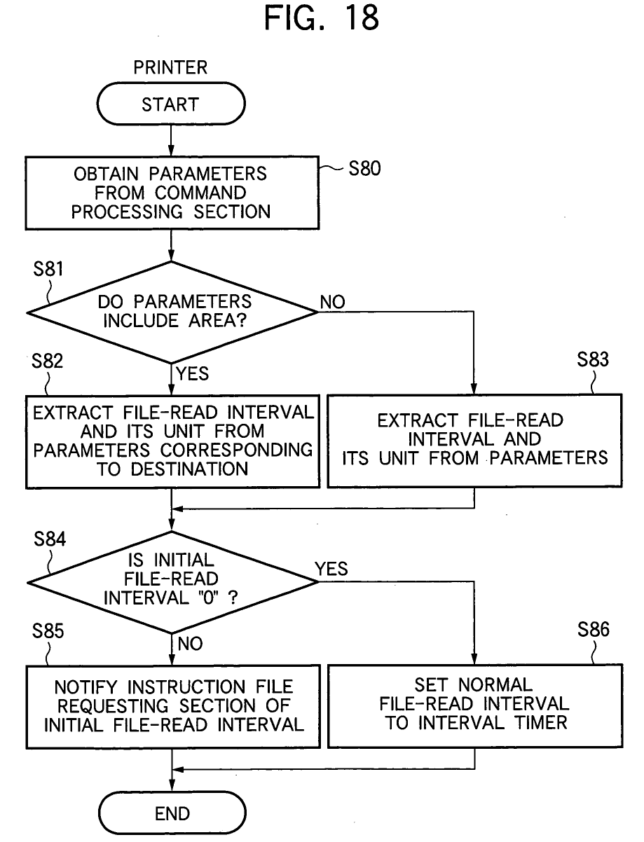

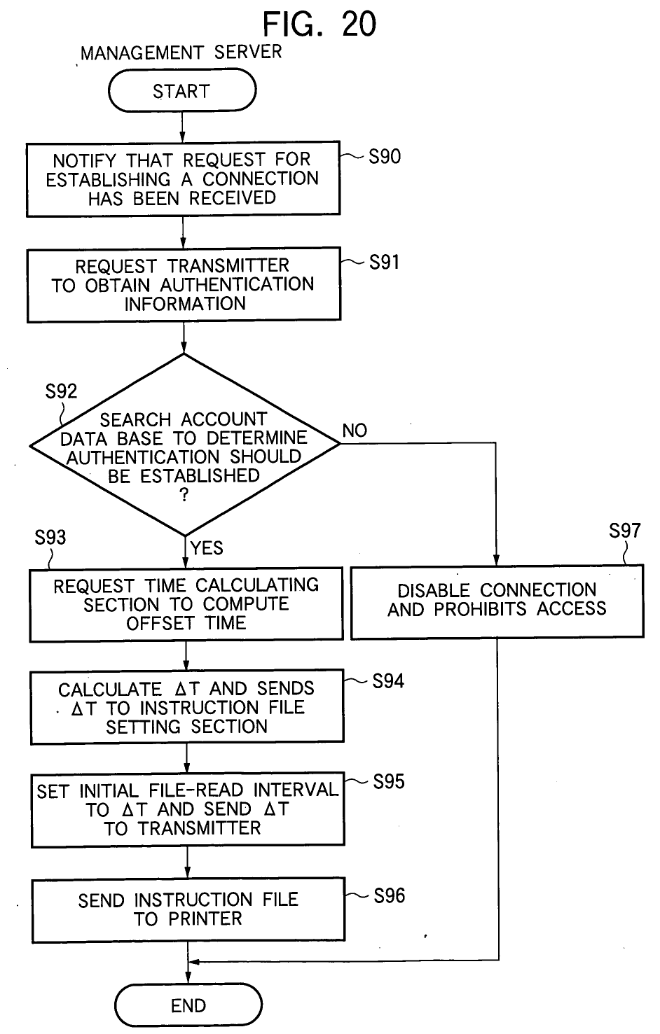

FIG. 17 is a schematic view of the management server. FIG. 18 is a flowchart illustrating the operation of the printer. FIG. 20 is a flowchart illustrating the operation of the management server. The operations of the respective sections will be described in detail with reference to FIG. 13, FIGS. 16-18, and FIG. 20.

{Operation of the Maintenance Terminal}

When the operator at the maintenance terminal 22, who is maintenance personnel, wants to obtain information such as a remaining amount of a consumable item in the printer and a value of Ts (i.e., a file-read interval at which the instruction file is read) on an are-by-area basis, the operator operates the operation panel of the maintenance terminal 22 to input an information items (e.g., remaining amount of a consumable item) and request for the information on the instruction file read interval. Then, a connection to the management server 21 is established to the management server 21. Subsequently, the instruction file in the management server 21 is modified in accordance with the information items that the operator input through the maintenance terminal 22.

The time setting Ts is a time-of-day at which the printer 1 reads the instruction file, and is specified through the maintenance terminals 22. The time setting Ts is held in the time-of-day specifying section 35. The time setting Ts is not the length of time but an absolute time of day such as “35 minutes past 2 o'clock PM.” The time setting Ts is temporarily stored in the time-of-day specifying section 35 of the management server 21, so that the management server 21 operates to modify the content of the instruction file at the time setting Ts.

{Connecting Between Printer and Management Server}

The connection between the printer and management server is accomplished in the same way as the first embodiment in FIG. 3. Additionally, the operation from step S20 where the instruction file is transmitted from the management server 21 to step S25 where the command decoding section 10 in the printer 1 processes commands is the same as the first embodiment. Thus, the detailed description of the connection between the printer and management server is omitted.

{Structure of Instruction File}

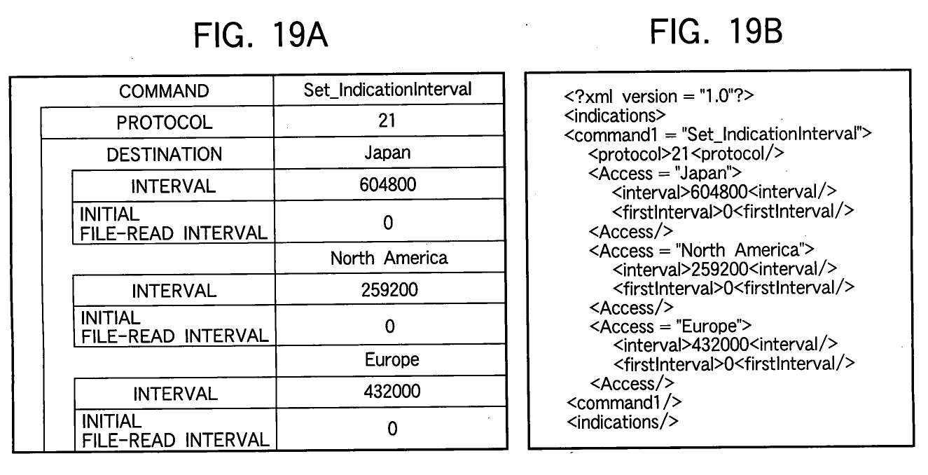

FIG. 19A illustrates an example of instruction file according to the fifth embodiment. FIG. 19B illustrates the content of the instruction file written in Extensible Markup Language (XML). The instruction file is such that one command has its associated parameters.

Referring to FIG. 19A and FIG. 19B, the command for setting a file-read interval is read is “Set_IndicationInterval”, and has a protocol as an associated parameter. Areas to be accessed include Japan, North America, and Europe. Each area is assigned a file-read interval and a first interval “firstInterval” which is set when the instruction file is read for the first time. In the present embodiment, the file-read interval is set in seconds so that printers having the same destination have the same file-read timing, i.e., the timing at which the instruction file is read. Alternatively, the file-read interval may be set in increments of less than 1 second or in increments of 1 minute.

If maintenance is to be carried out for only a limited area, then the area need not be specified. Instead, the parameters may include one protocol, one value of instruction file read, and one initial read. Instead of grouping areas into those in FIG. 19A and FIG. 19B, areas may be specified on a country-by-country basis or in terms of smaller regions within each country.

{Operation of Command Processing Section}

After having been connected to the management server 21 (steps S1-S12 in FIG. 3), the printer 1 obtains the instruction file in FIG. 19B from the management server 21 (steps S20-S25 in FIG. 4).

Then, the command processing section 11 obtains a command “read interval modifying command” and its associated parameters, decoded by the command decoding section 10 from the description in the instruction file in FIG. 19B (step S80). Then, the command processing section 11 initiates “read interval modifying processing” to determine whether the associated parameters include an area (step S81). If the associated parameters include an area, the program proceeds to step S82.

In other words, the command processing section 11 performs the read interval modifying processing as follows: The destination information is read from the destination data base 13. Then, area that corresponds to the destination information is retrieved from the instruction file. Finally, a file-read interval is read is extracted from the parameter corresponding to the corresponding area. The unit of the file-read interval is also extracted from the parameter that has the corresponding area (step S82).

For destination information “Europe” in the instruction file in FIGS. 19A and 19B, “<Access=“Europe”>” is retrieved. Then, a file-read interval “432000 seconds” is extracted from the description “<interval>432000<interval/>” and the first interval “0” is extracted from the description “<firstInterval>0<firstInterval/>”.

It is common to all areas that a protocol is “21” and communication is performed in FTP. This is extracted from “<protocol>21<protocol/>”.

The initial or first value of file-read interval is a parameter used to ensure that the same file-read interval is set to a plurality of printers that are destined to the same area. The first value of file-read interval may be modified within a management server that stores the instruction file therein.

If it is determined at step S81 that an area is not described in the obtained parameter, then a protocol, a file-read interval, and an initial value file-read interval are extracted (step S83). If the obtained parameters contain area information but the area information does not match up with the destination information of the printer, it is preferable to notify the management server 21.

If the initial value of file-read interval is not “0”, the program proceeds to step S85 (step S84).

In other words, if the initial value of file-read interval is not “0”, it is determined that the management server 21 has computed and set an offset time ΔT. Thus, the value of the offset time ΔT is sent as a value of interval to the instruction file requesting section 7 and then the program ends (step S85) Thus, the offset time ΔT is set to the interval timer 8. When the instruction file is read for the first time, a value of interval different from the normal value of interval is set at step S1 of FIG. 3 in which the printer 1 is connected to the management server 21.

If it is determined at step S84 that the initial value of file-read interval is “0” and therefore the offset time A T has not been computed, the normal file-read interval (e.g., 432000 seconds in this embodiment) is set to the interval timer 8 and the program ends (step S86).

{Operation of Management Server}

As shown in FIG. 20, upon receiving a request for establishing a connection from an apparatus to be maintained, e.g., the printer 1 (this step corresponds to step S5 in FIG. 3), the management server notifies the log-in controller 34 that the request for establishing a connection has been received (step S90).

Then, the log-in controller 34 requests the transmitter 31 of the authentication information such as an account name and a password (step S91, step S6 in FIG. 3). In response to this request, the printer 1 sends the account name and password to, for example, the management server (step S9 in FIG. 3).

Upon receiving the authentication information, the log-in controller 34 searches the account data base 40 to determine whether a connection to the printer 1 should be established, i.e., authentication should be established (step S92). In other words, if the account received from the printer 1 coincides with one in the account data base 40 so that authentication information such as password coincides, it is determined that authentication has been established (step S10 in FIG. 3) and the program proceeds to step S93.

Once the log-in controller 34 has established authentication between the printer 1 and the management server 21, the printer 1 enters a standby state in which the printer waits for a command. Upon receiving a request for transmission of the instruction file, the receiver 32 sends the request for transmission of the instruction file to the instruction file setting section 38 through the log-in controller 34. Then, the instruction file setting section 38 permits the printer 1 to access the file storing section 39, and performs the following processing.

In other words, if the instruction file describes “<firstInterval>0<firstInterval/>”, i.e., the initial file-read interval is “0”, the instruction file setting section 38 requests the time calculating section 36 to compute the offset time AT which will be described later (step S93) The time calculating section 36 obtains the time setting Ts from the time-of-day specifying section 35 and the current time TO from the clock section 37. Then, the time calculating section 36 computes ΔT (ΔT=Ts−T0) and sends the ΔT to the instruction file setting section 38 (step S94).

The instruction file setting section 38 sets the initial file-read interval to ΔT seconds, and sends it to the transmitter 31 (step S95). Then, the transmitter 31 transmits the instruction file to the printer 1 which is a request source. Then, the program ends (step S96 in FIG. 20 and step S20 in FIG. 3).

If the account name does not exist or the passwords are not coincident at step S92, the log-in controller 34 refuses a connection (step S97).

With the aforementioned operation, if the printer 1 has read the instruction file at least one time, the printer 1 can set the instruction file read time to nearly equal to Ts. The time setting Ts may be specified to individual areas for which the printers 1 are destined, so that all the printers destined to the same area can have the same file-read timing.

As described above, in the fifth embodiment, the offset time is computed and the instruction file is modified so as to set the same time setting Ts. Alternatively, the printer 1 may have a clock section and the time setting may be written directly into the instruction file.

While the fifth embodiment has been described with respect to a case where the file-read interval and the file-read interval can be specified depending on the destination for which the printer 1 is destined. Alternatively, the file-read interval and the initial file-read interval may be specified depending on, for example, the model of the printer 1.

According to the fifth embodiment, by means of the instruction file stored in the management server, the time of day at which the printer reads the instruction file may be specified and the time of day may be further specified on a printer-by-printer basis. Thus, the fifth embodiment provides the following additional advantages as well as those of the first to fourth embodiments.

The time of day at which the server is accessed may be specified. Therefore, the time frame during which the server is not accessed may be easily set, facilitating the maintenance of the server.

Information that has been obtained before a predetermined time of day may be analyzed and summarized on a printer-by-printer basis.

The frequency at which the printer accesses the server may be set in accordance with the frequency at which the printer is used, the infrastructure improvement of the Internet, and the capacity of the management server.

{Modifications}

The following modifications may be made and offer similar advantages to the aforementioned embodiments.

While the first to fifth embodiments have been described with respect to an instruction file written in XML, the instruction file may be written in any arbitrary text format or binary format.

Although the embodiments have been described in terms of the account data base 6 provided in the printer 1, the account data base 6 may be provided commonly in the management servers at the network addresses.

The embodiments have been described in terms of a case in which the file-read timing is modified through the maintenance terminal 22 is independent from the file-read timing is performed by the printer 1. Instead, the printer 1 may be notified when the instruction file is modified through the maintenance terminal 22, so that the first file-read timing is the same.

The first to fifth embodiments have been described in terms of a case in which all the printers destined to the same area can have the same read time timing. Alternatively, the information transmission time may be written in the instruction file so that the information transmission time may be independent from the file-read timing.

The embodiments have been described with respect to a case in which the content of the instruction file is modified through the maintenance terminal 22 connected to the network 30. Alternatively, a connection may be made directly to the management server 21 instead of through the network 30. Still alternatively, instead of providing the maintenance terminal 22, the content of the instruction file may be altered by operating the operation panel of the management server 21.

As described above, the present invention may be applicable to systems and service in which copying machines including printers may be remotely maintained over the intranet and the Internet.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. An apparatus that is maintained by a piece of equipment through a network, comprising:
a reading section that reads an instruction file from the equipment, the instruction file containing an instruction necessary for maintenance of the apparatus; and
a controller that generates a reply in response to the instruction.

2. The apparatus according to claim 1, wherein the device is the piece of equipment.

3. The apparatus according to claim 1, wherein the device is an information storing server connected to the network.

4. The apparatus according to claim 1, wherein the apparatus receives an update program from another device in response to the instruction.

5. The apparatus according to claim 1, wherein said reading section reads the instruction file at regular time interval.

6. The apparatus according to claim 1, wherein said reading section reads the instruction file at a time interval specified by the instruction file.

7. An apparatus that maintains a piece of equipment through a network, comprising:
a time storing section that stores a specified time;
a clock section that outputs a signal representative of a current time;
a time calculating section that calculates a difference between the current time and the specified time and writes the difference into an instruction file, the difference being calculated after the apparatus has received a request from the equipment to send an instruction file and before the instruction file is sent to the equipment; and
a storing section that stores the instruction file.

8. A maintenance system comprising a first apparatus and a second apparatus that is maintained by the first apparatus, wherein the first apparatus produces an instruction file that contains time information; and
the second apparatus reads the instruction file from the first apparatus and reads the instruction file at a time specified by the time information when the second apparatus reads the instruction subsequently.

9. The maintenance system according to claim 8, wherein the first apparatus produces the time information based on a value of time information and a current time.
